(19) United States
(12) Patent Application Publication
(10) Pub. No.: US 2009/0144777 A1
(43) Pub. Date: Jun. 4, 2009

(54) REAL-TIME MOST WATCHED GUIDE ORDERING AND GENERATION

(75) Inventors: Jason Mikami, Oakland, CA (US); Todd Stiers, Berkeley, CA (US)

Correspondence Address: Weaver Austin Villeneuve & Sampson LLP, P.O. BOX 70250, OAKLAND, CA, 94612-0250, US

(73) Assignee: MOBITV, INC., Emeryville, CA (US)

(21) Appl. No.: 11/947,652

(22) Filed: Nov. 29, 2007

(51) Int. Cl. G06F 3/00

(52) U.S. Cl. 725/50

(57) ABSTRACT

Mechanisms are provided for allowing a user to dynamically obtain program guide data and select video content in an efficient and effective manner. A guide generator is configured to obtain program guide information from multiple sources including content providers. The guide generator compiles a real-time most watched program guide by determining viewing patterns associated with various channels and video clips. Channels and video clips requested most frequently are listed first. A real-time most watched program guide including data such as program titles, times, icons, and links is then provided and displayed as needed on client devices. Potentially limitless amounts of program guide data can be provided on a client device while still allowing a user to efficiently and effectively select video content.

### DESCRIPTION OF RELATED ART

The present disclosure relates to electronic program guides. In some examples, the techniques of the present disclosure provide mechanisms for generating real-time most watched electronic program guides.

Electronic program guides provide users with information to allow video content selection. Some electronic program guides provide hundreds or thousands of options including numerous channels and video on demand clips. However, mechanisms for sorting through the options and selecting video content are limited. Consequently, the techniques and mechanisms of the present invention provide improved mechanisms for ordering and generating electronic program guides to allow users to more efficiently select video content.

### OVERVIEW

Mechanisms are provided for allowing a user to dynamically obtain program guide data and select video content in an efficient and effective manner. A guide generator is configured to obtain program guide information from multiple sources including content providers. The guide generator compiles a real-time most watched program guide by determining viewing patterns associated with various channels and video clips. Channels and video clips requested most frequently are listed first. A real-time most watched program guide including data such as program titles, times, icons, and links is then provided and displayed as needed on client devices. Potentially limitless amounts of program guide data can be provided on a client device while still allowing a user to efficiently and effectively select video content.

In particular embodiments, a technique is provided. Real-time video content requests are received at a server from client devices. A real-time most watched electronic program guide is compiled using real-time video content requests to derive an ordering of content for the real-time most watched electronic program guide. A request is received for electronic program guide information from a first client device and the real-time most watched electronic program guide is sent to the first client device for display on the first client device. Real-time most watched electronic program guide content is provided before least watched electronic program guide content.

In other particular embodiments, a system is provided. The system includes an interface and a processor. The interface is operable to receive real-time video content requests from client devices. The processor is operable to compile a real-time most watched electronic program guide. The real-time video content requests are used to derive an ordering of content for the real-time most watched electronic program guide. The interface is also operable to receive a request for electronic program guide information from a first client device and send the real-time most watched electronic program guide to the first client device for display on the first client device. The real-time most watched electronic program guide content is provided before least watched electronic program guide content.

These and other features of the present invention will be presented in more detail in the following specification of the invention and the accompanying figures, which illustrate by way of example the principles of the invention.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates a particular example of a network that can use the techniques and mechanisms of the present invention.

FIG. 2 illustrates a particular example of a content delivery system.

FIG. 3 illustrates a particular example of a program guide.

FIG. 4 illustrates another particular example of a program guide.

FIG. 5 illustrates a particular example of a device guide request sequence.

FIG. 6 illustrates a particular example of server processing for generating a real-time most watched guide.

FIG. 7 illustrates a particular example of server processing for providing a most watched guide.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular devices such as mobile devices. However, it should be noted that the techniques and mechanisms of the present invention can be used with a variety of devices including general computing devices. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a processor is used in a variety of contexts. However, it will be appreciated that multiple processors can also be used while remaining within the scope of the present invention unless otherwise noted. Furthermore, the techniques and mechanisms of the present invention will sometimes describe two entities as being connected. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Selecting video content on a device such as a mobile phone or a portable computing device can often be inefficient. In many instances, subscription packages provide hundreds of channels and thousands of video on demand clips. It is difficult for a user to identify interesting or exciting content. In some instances, electronic program guides can organize content by category, such as dramas, sports, or movies and provide the content in numerically ordered channel listings. In some other instances, popularly rated programs or award winning content is flagged for a user. Electronic program guides may also be filtered. In some examples, non-family oriented programming is filtered based on user selection.

However, providing thousands of channels and video clips to a user results in a large of amount of information and choices. This information may be shown in a part of a display or condensed onto a device screen. The information may scroll automatically or may scroll after user input. In many instances, channels and video clips may be listed in numerical order or alphabetical order. In either case, it takes a tremendous amount of time to sift through content, and even after viewing the titles, a user still may have insufficient information to make an intelligent selection.

Consequently, the techniques and mechanisms of the present invention contemplate providing a content listing ordered based on real-time most watched data. For example, a program currently being watched by the most viewers is listed first, while the next most watched program is listed second. This program listing is provided based on real-time viewership information. In many applications, acquiring this information is not possible for the generation of program guides. For example, ratings and popularity information for shows is often compiled well after a show has finished airing. However, the techniques and mechanisms of the present invention provide an architecture that allows the generation of real-time most watched program guides.

According to various embodiments, users send requests for video stream to content servers. These content servers and associated processing systems compile real-time viewing information. At a particular time period, a content server may receive hundreds of thousands of requests for a particular sporting event on one channel, and possibly only tens of thousands of requests for a particular movie on another channel. A server can compile all of this information to reorder a conventional program guide. The viewership information can be continuously compiled to continuously generate real-time most watched program guides. The real-time most watched program guide or a portion of the real-time most watched program guide can be provided to a user at any time. In many instances, the real-time most watched program guide is provided to a user upon request.

Downloading even time limited program guide data for hundreds or thousands of channels would use memory and network resources typically not available for mobile devices. Consequently, the techniques of the present invention allow for the download and display of potentially limitless program guide data. In some examples, just enough program guide structure information is downloaded and displayed to allow a user to navigate a program guide. Any program guide data allowing a user to begin navigating a program guide is referred to herein as program guide structure information. In some examples, program guide structure information is a listing of subscribed channels or a listing of groups of channels. For example, a user can view a table of channels available in a particular geographic area. The mobile device then begins accessing program content information.

Program content information includes details used to complete program guide structure information to create a program guide. In particular embodiments, program content information for the real-time most watched programs is downloaded first. In some examples, program content information includes program titles, times, icons, program descriptions, links, graphics, etc associated with the real-time most watched programs. In one example, when a user scrolls to next block of channels, the next most popular programs are downloaded. A dynamic request is transmitted for program guide content information corresponding to the user request. Program guide structure information requests remain infrequent because requests for program guide structure information can be dependent on the user and on subscription rights.

The request is database intensive since it has potentially different results for every user. While the user is navigating guide parts, program guide content requests are transmitted. According to various embodiments, program guide content requests are numerous. In some examples, real-time most watched program guides are generated periodically and cached. The program guide content can be delivered rapidly from cache. Consequently, performance is improved for delivery of program guide data for mobile devices. In other examples, it is contemplated that some program guide content information can be preemptively obtained based on usage patterns. For example, if it is determined that a user views the listings of a dozen of so most popular programs, program guide content for channels seen when scrolling down a few screens can be preemptively downloaded.

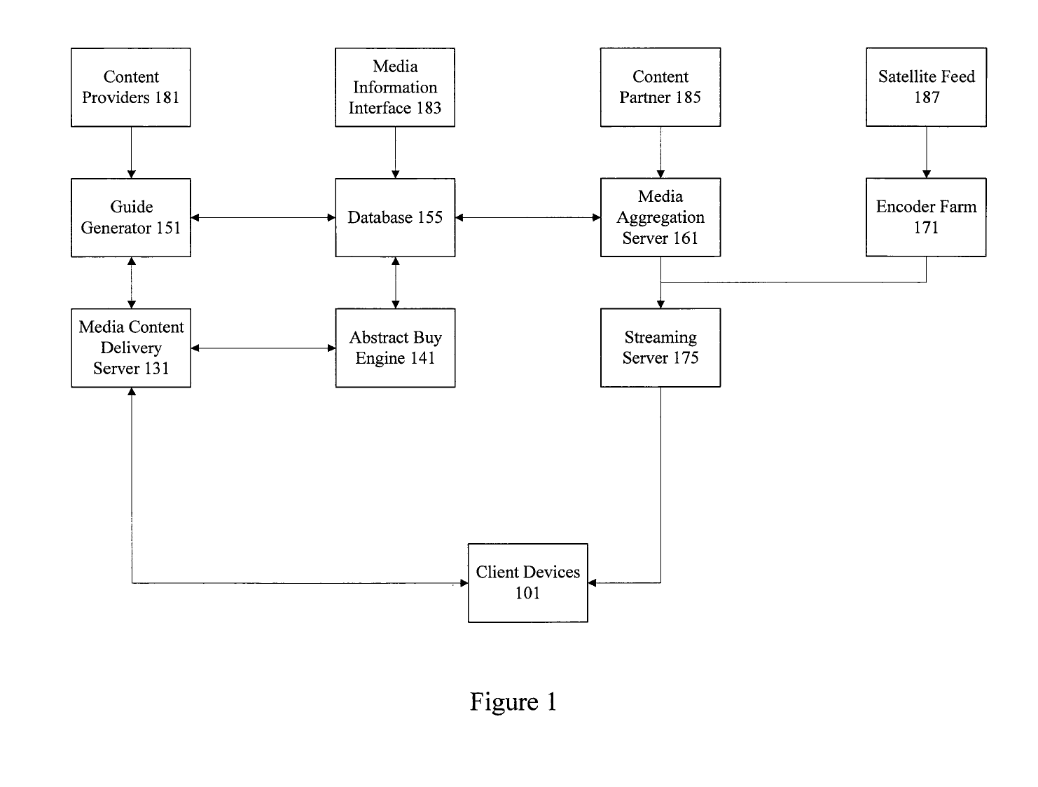

FIG. 1 is a diagrammatic representation showing one example of a network that can use the techniques of the present invention. According to various embodiments, media content is provided from a number of different sources 185. Media content may be provided from film libraries, cable companies, movie and television studios, commercial and business users, etc. and maintained at a media aggregation server 161. Any mechanism for obtaining media content from a large number of sources in order to provide the media content to mobile devices in live broadcast streams is referred to herein as a media content aggregation server. The media content aggregation server 161 may be clusters of servers located in different data centers. According to various embodiments, content provided to a media aggregation server 161 is provided in a variety of different encoding formats with numerous video and audio codecs. Media content may also be provided via satellite feed 157.

An encoder farm 171 is associated with the satellite feed 187 and can also be associated with media aggregation server 161. The encoder farm 171 can be used to process media content from satellite feed 187 as well as possibly from media aggregation server 161 into potentially numerous encoding formats. According to various embodiments, file formats include open standards MPEG-1 (ISO/IEC 11172), MPEG-2 (ISO/IEC 13818-2), MPEG-4 (ISO/IEC 14496), as well as proprietary formats QuickTime™, ActiveMovie™, and RealVideo™. Some example video codecs used to encode the files include MPEG-4, H.263, and H.264. Some example audio codecs include Qualcomm Purevoice™ (QCELP), The Adaptive Multi-Narrow Band (AMR-NB), Advanced Audio coding (AAC), and AACPlus. The media content may also be encoded to support a variety of data rates. The media content from media aggregation server 161 and encoder farm 171 is provided as live media to a streaming server 175. In one example, the streaming server is a Real Time Streaming Protocol (RTSP) server 175. Media streams are broadcast live from an RTSP server 175 to individual client devices 101. A variety of protocols can be used to send data to client devices.

Possible client devices 101 include personal digital assistants (PDAs), cellular phones, personal computing devices, personal computers etc. According to various embodiments, the client devices are connected to a cellular network run by a cellular service provider. IN other examples, the client devices are connected to an Internet Protocol (IP) network. Alternatively, the client device can be connected to a wireless local area network (WLAN) or some other wireless network. Live media streams provided over RTSP are carried and/or encapsulated on one of a variety of wireless networks.

The client devices are also connected over a wireless network to a media content delivery server 131. The media content delivery server 131 is configured to allow a client device 101 to perform functions associated with accessing live media streams. For example, the media content delivery server allows a user to create an account, perform session identifier assignment, subscribe to various channels, log on, access program guide information, obtain information about media content, etc. According to various embodiments, the media content delivery server does not deliver the actual media stream, but merely provides mechanisms for performing operations associated with accessing media. In other implementations, it is possible that the media content delivery server also provides media clips, files, and streams. The media content delivery server is associated with a guide generator 151. The guide generator 151 obtains information from disparate sources including content providers 181 and media information sources 183. The guide generator 151 provides program guides to database 155 as well as to media content delivery server 131 to provide to client devices 101.

According to various embodiments, the guide generator 151 obtains viewership information from individual client devices. In particular embodiments, the guide generation 151 compiles viewership information in real-time in order to generate a most-watched program guide listing most popular programs first and least popular programs last. The client device 101 can request program guide information and the most-watched program guide can be provided to the client device 101 to allow efficient selection of video content. According to various embodiments, guide generator 151 is connected to a media content delivery server 131 that is also associated with an abstract buy engine 141. The abstract buy engine 141 maintains subscription information associated with various client devices 101. For example, the abstract buy engine 141 tracks purchases of premium packages.

The media content delivery server 131 and the client devices 101 communicate using requests and responses. For example, the client device 101 can send a request to media content delivery server 131 for a subscription to premium content. According to various embodiments, the abstract buy engine 141 tracks the subscription request and the media content delivery server 131 provides a key to the client 101 to allow it to decode live streamed media content. Similarly, the client device 101 can send a request to a media content delivery server 131 for a most-watched program guide for its particular program package. The media content delivery server 131 obtains the guide data from the guide generator 151 and associated database 155 and provides appropriate guide information to the client device 101.

Although the various devices such as the guide generator 151, database 155, media aggregation server 161, etc. are shown as separate entities, it should be appreciated that various devices may be incorporated onto a single server. Alternatively, each device may be embodied in multiple servers or clusters of servers. According to various embodiments, the guide generator 151, database 155, media aggregation server 161, encoder farm 171, media content delivery server 131, abstract buy engine 141, and streaming server 175 are included in an entity referred to herein as a media content delivery system.

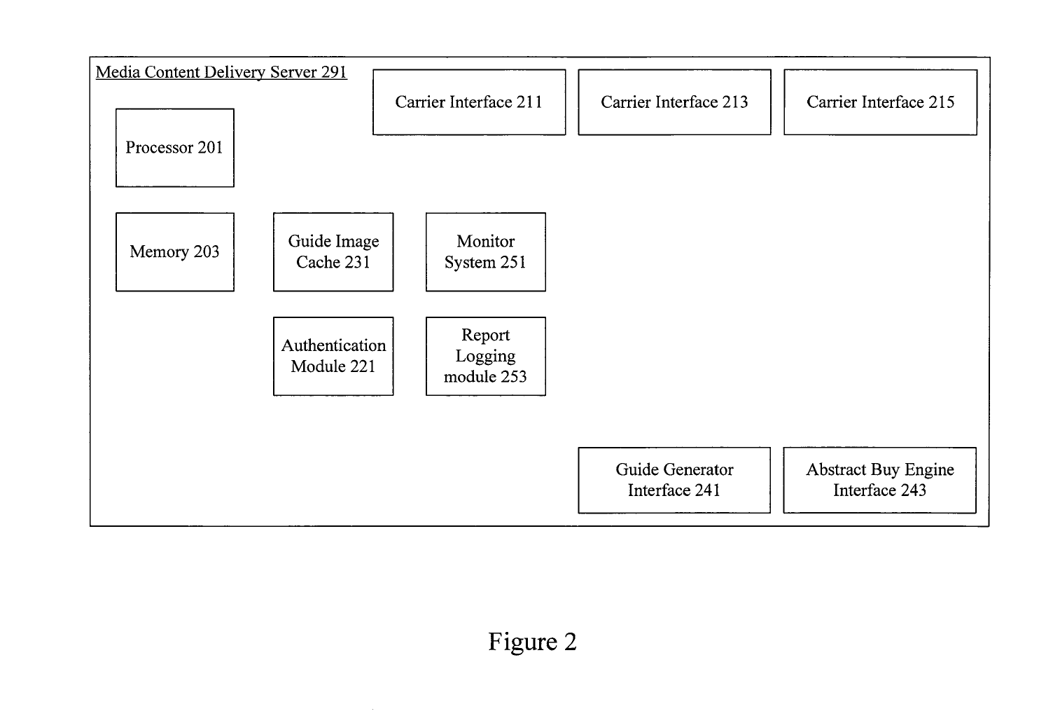

FIG. 2 is a diagrammatic representation showing one example of a media content delivery server 291. According to various embodiments, the media content delivery server 291 includes a processor 201, memory 203, and a number of interfaces. In some examples, the interfaces include a guide generator interface 241 allowing the media content delivery server 291 to obtain program guide information. The media content delivery server 291 also can include a program guide cache 231 configured to store program guide information and data associated with various channels. The media content delivery server 291 can also maintain static information such as icons and menu pages. The interfaces also include a carrier interface 211 allowing operation with mobile devices such as cellular phones operating in a particular cellular network. The carrier interface allows a carrier vending system to update subscriptions. Carrier interfaces 213 and 215 allow operation with mobile devices operating in other wireless networks. An abstract buy engine interface 243 provides communication with an abstract buy engine that maintains subscription information.

An authentication module 221 verifies the identity of mobile devices. A logging and report generation module 253 tracks mobile device requests and associated responses. A monitor system 251 allows an administrator to view usage patterns and system availability. According to various embodiments, the media content delivery server 291 handles requests and responses for media content related transactions while a separate streaming server provides the actual media streams. In some instances, a media content delivery server 291 may also have access to a streaming server or operate as a proxy for a streaming server. But in other instances, a media content delivery server 291 does not need to have any interface to a streaming server. In typical instances, however, the media content delivery server 291 also provides some media streams. The media content delivery server 291 can also be configured to provide media clips and files to a user in a manner that supplements a streaming server.

Although a particular media content delivery server 291 is described, it should be recognized that a variety of alternative configurations are possible. For example, some modules such as a report and logging module 253 and a monitor 251 may not be needed on every server. Alternatively, the modules may be implemented on another device connected to the server. In another example, the server 291 may not include an interface to an abstract buy engine and may in fact include the abstract buy engine itself. A variety of configurations are possible.

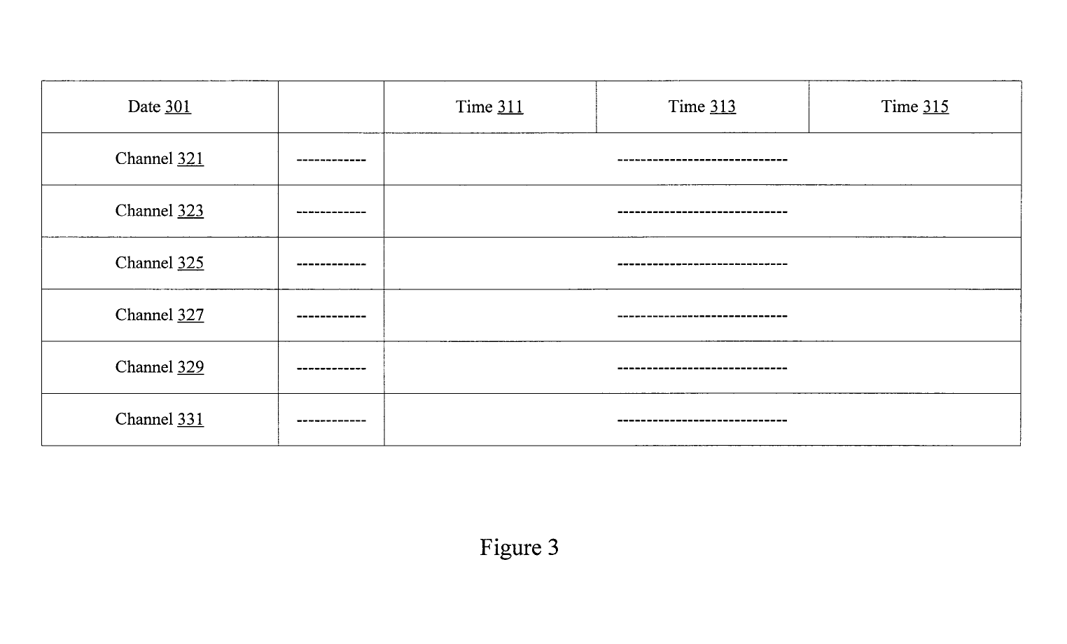

FIG. 3 is an exchange diagram depicting one example of program guide structure information. In some examples, the times 311, 313, and 315 cover a time range from time 311 through time 315, such as 3 pm to 5 pm. The program guide structure information provides information identifying channels 321, 323, 325, 327, 329, and 331. In some examples, program guide structure information includes a table of hundreds of channels. According to various embodiments, the program guide is ordered based on real-time determined popularity of programs. That is, the program guide is ordered based on the number of users watching a particular program at that particular time. A program guide can be created by a guide generator from information provided by a variety of content providers and compiled from a number of different users. The program guide structure information may include a listing of channels and not program guide content information for hundreds or thousands of channels.

Available systems download program guide information for all available channels or substantially all subscribed channels. In many instances, an entire program guide is downloaded. Downloading an entire program guide can take an unreasonably long period time, use considerable bandwidth, and consume resources on a device. For mobile devices with media capabilities operating in wireless networks, it is contemplated that it is beneficial to download program guide structure to allow a user to begin navigating while downloading program guide content dynamically based on demand from a user. In some examples, program guide content is downloaded in blocks with the most popular content downloaded first.

The program guide content block size may be determined based on the size of available mobile device memory. In another alternative, a program guide information block size is based upon data transmission rates, server cache block sizes, or available bandwidth. A wide variety of criteria and combinations of criteria can be used in determining a program guide information block size. In other examples, just enough data is downloaded to display a list and allow a user to begin to navigate the program guide information. As the user views different parts of the guide, the detailed content of the guide is downloaded separately and displayed as needed. There is no need to download the entire guide. Only what the user needs to view is downloaded on demand. Potentially limitless guide data can be downloaded in this manner. The user gets immediate feedback and does not need to wait for the data. The guide is not limited to the memory storage on the device or the service bandwidth. Guide data can be constantly updated since only the visible portion needs to be downloaded.

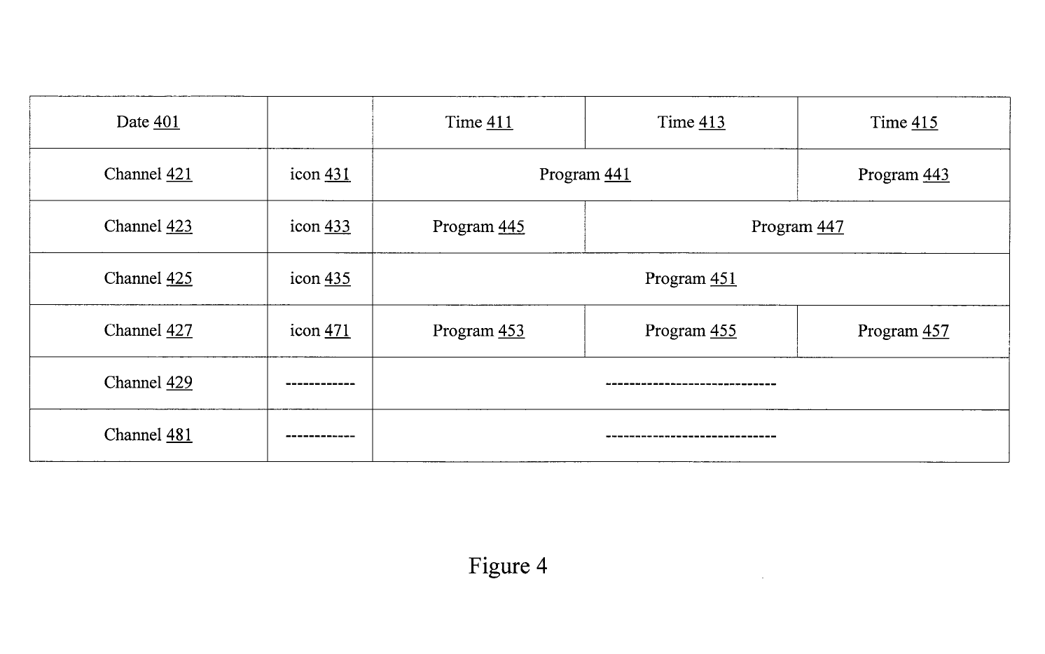

FIG. 4 depicts program guide structure information and program guide content information. In one example, program guide structure such as a listing of channels or at least a partial listing of channels is initially downloaded to allow a user to begin navigating. The block of program guide content information is associated with date 401 and times 411, 413, and 415. In another example, the times 411, 413, and 415 cover a time range from time 411 through time 415, such as 3 pm to 5 pm. Programs 441, 443, 445, 447, 451, 453, 455, and 457 are included in the program guide information block. The program guide information block shows program guide information for channels 421, 423, 425, 427, 429, and 481. In some examples, a program guide includes information for thousands of channels and video clips. A program guide can be created by a guide generator from information provided by a variety of content providers and from viewership information. Program guide structure information can be unique to each user. According to various embodiments, program guide content information is maintained in relatively generic form and can be cached on a server.

In some examples program guide content information only provides information for channels 421, 423, 425, and 427 and not for hundreds or thousands of other channels. The channels 421, 423, 524, and 427 may corresponding to channels carrying the most watched content at a particular time. A mobile device screen may only be sufficient to display a portion of the program guide information block. For example, the mobile device screen may only show information for channels 421, 423, and 425. Nonetheless, some extra information may be downloaded in anticipation of a user requesting that information. Although the channels shown are contiguous, it should be noted that channels and times as well do not have to be contiguous.

In some examples, a media content delivery server can remember channels or groups of channels frequently accessed by a user and provide the channels or groups of channels as part of a block of program guide information. In another example, a media content delivery server can recognize that a user typically views about a dozen or so popular channels and provide several pages of scroll down program guide information to a user preemptively even before the user performs any scrolling. In still other examples, a media content delivery server can recognize user viewing or listening patterns and download blocks of program guide content information believed to be of interest to a user. Similarly, a media content delivery server can determine times when media is frequently accessed and provide blocks of program guide information based on viewing times. A wide variety of algorithms can be implemented to intelligently select portions of program guide content information for download to a mobile device without having to download the entire program guide. Resources can be conserved while still providing the user with an active and dynamic experience.

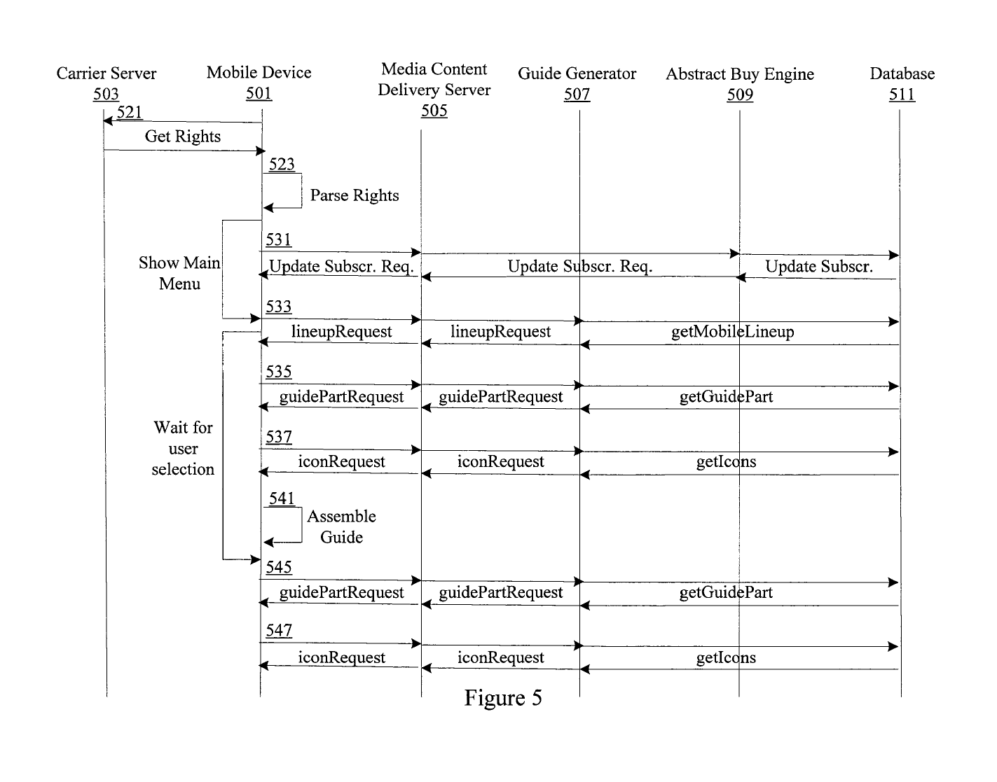

FIG. 5 is an exchange diagram showing one example of a mobile guide delivery sequence. A mobile device 501 obtains subscription service rights information from a carrier server 503. According to various embodiments, the mobile device parses and displays information associated with the rights at 523. In one example, a root menu showing subscribed and available channels is shown.

According to various embodiments, the mobile device 501 sends an update subscriptions request message at 531 to a media content delivery server 505. The media content delivery server 505 forwards the update subscriptions request message to an abstract buy engine 509. The abstract buy engine 509 sends an update subscriptions message to the database 511. The mobile device 501 also sends a lineup request message 535 to the media content delivery server 505. The lineup request message is forwarded to a guide generator 507. The guide generator obtains a lineup for the mobile device from the database 511. The abstract buy engine 509 is not involved in this particular request transaction. At 535, the mobile device sends a guide part request to the media content delivery server 505. In some examples, the request is a request for the entire program guide. In typical examples, the request is a request for a portion of the guide or a program guide information block. The program guide information block request is forwarded to a guide generator 507. The guide generator obtains the guide part from a database 511 or generates it based on other information.

In some examples, icons are also requested by the mobile device 501 at 537. The mobile device 501 sends an icon request to the media content delivery server 505. The media content delivery server 505 forwards the icon request to the guide generator 507. The guide generator obtains icons from the database 511. According to various embodiments, other information such as advertisements and media clips are also requested or provided along with the icons. At 541, the guide is assembled at the mobile device 501. According to various embodiments, the most popular real-time content is shown and display first. The user can then scroll through the guide or jump to a particular location in the guide. Some portions of the guide may not yet be downloaded. Consequently, additional guide part requests and icon requests may be sent by a mobile device 501 at 545 and 547. The additional program guide information block requests and icon requests at 545 and 547 may be sent for different channels, different channel blocks, or different time periods.

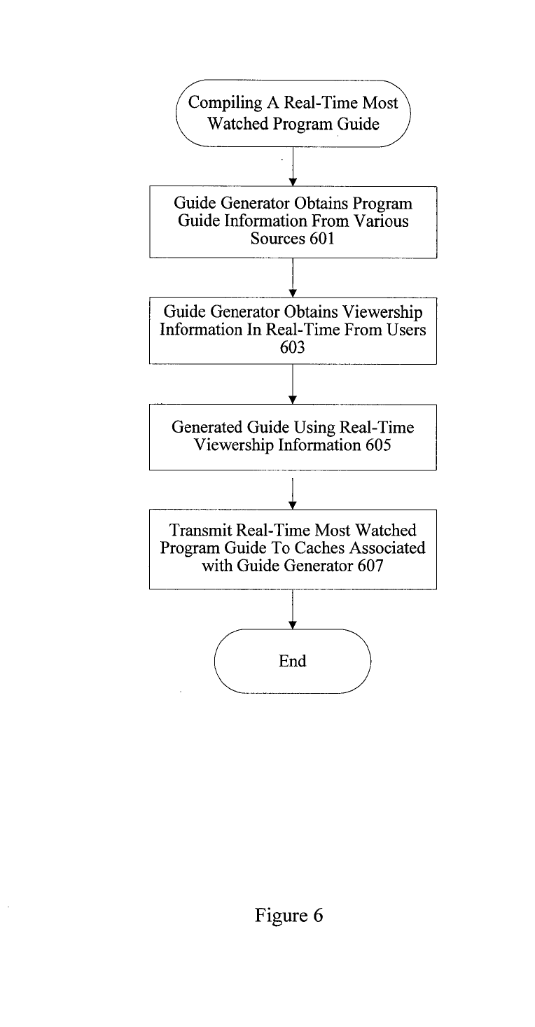

FIG. 6 is a flow process diagram showing one example of a technique for compiling a real-time most watched program guide. At 601, a guide generator obtains program guide information from various sources such as content providers. The program guide information gives program descriptions, titles, ratings, as well as time and data information. At 603, the guide generator also obtains viewership information in real-time from users. According to various embodiments, the guide generator can obtain viewership information by monitoring the number of user requests for particular programs. Alternatively, the guide generator can monitor the number of streams for particular programs sent to client devices. In particular embodiments, video content server transactions are monitored to determine viewership activity. At 605, the guide generator compiles a real-time most watched program guide. According to various embodiments, this real-time most watched program guide may be compiled constantly and broadcast to caches whenever significant change is noted. In particular embodiments, the real-time most watched program guide can be compiled every 5 minutes.

At 607, the real-time most watched program guide is transmitted to caches associated with the guide generator to allow rapid retrieval of content. According to various embodiments, the program guide can be continuously updated and reordered based on viewership information. In particular embodiments, a simple numerical ranking is sent as updates to individual users. The rankings allow individual client devices to order channels and video clips in an order desired. In still other embodiments, only a subset of the most popular programs are ranked. Other video content can still be provided in channel based numerical order. For example, the real-time most popular video content can be provided as a first page of a program guide. The entire program guide can be provided below are most watched section.

According to particular embodiments, the real-time most watched electronic program guide is provided to client devices and displayed in order of real-time popularity. Real-time most watched electronic program guide content can be provided before least watched electronic program guide content.

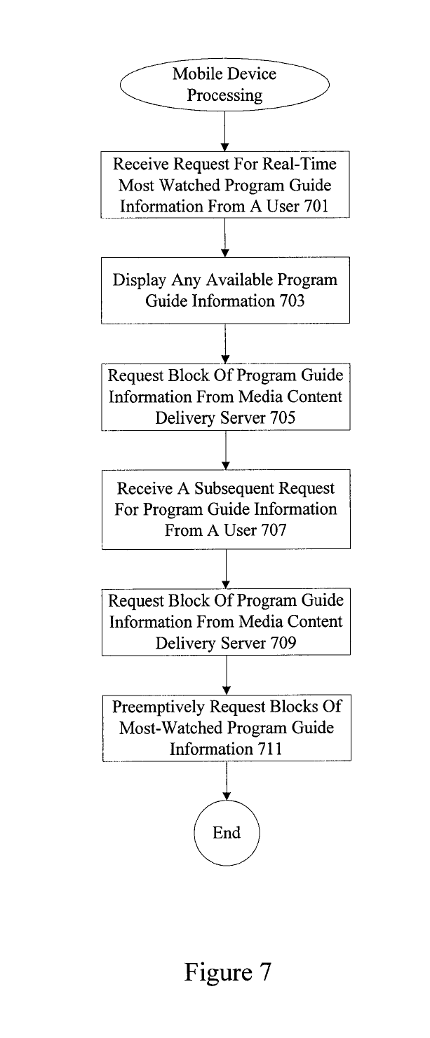

FIG. 7 is a flow process diagram showing one example of a request for program guide information. At 701, a request for program guide information is received from a user. The request may result from a user selection to view a certain portion of a program guide. According to various embodiments, some program guide information may already be available on the device. For example, a listing of channels may be available. At 703, any program guide information available is displayed. At 705, a client device requests a block of program guide information from a media content delivery server. The block of program guide information may have a size determined by the screen of a client device. Alternatively, the block of program guide information may have a size determined by the amount of memory available on the client device. Other considerations such as bandwidth availability can also be taken into account. According to particular embodiments, the real-time most popular video content is provided in a first block. At 707, a client device receives a subsequent request from a user for program guide information.

According to various embodiments, the subsequent request results from a user scrolling, jumping, or otherwise navigating to a particular portion of a program guide. If the client device does not already have the information, the block of program guide information is requested from a media content delivery server at 709. It should be noted that program guide information can also be requested from other entities related to media content delivery servers. At 711, blocks of program guide information can be preemptively requested. Alternatively, blocks of program guide information can be preemptively provided to a client device. A variety of client devices can be used. According to various embodiments, a client device includes a display, a processor, memory, an interface operable to communicate with a media content delivery server, and an input interface operable to allow a user to operate the device. Possible client devices include cellular phones, personal digital assistants, portable computing devices, etc.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method, comprising:
receiving real-time video content requests at a server from a plurality of client devices;
compiling a real-time most watched electronic program guide, wherein real-time video content requests are used to derive an ordering of content for the real-time most watched electronic program guide;
receiving a request for electronic program guide information from a first client device;
sending the real-time most watched electronic program guide to the first client device for display on the first client device, wherein real-time most watched electronic program guide content is provided before least watched electronic program guide content.

2. The method of claim 1, wherein the real-time most watched electronic program guide is provided to the first client device in blocks.

3. The method of claim 2, wherein a first block includes real-time most watched content.

4. The method of claim 3, wherein subsequent blocks include a channel order program guide.

5. The method of claim 1, wherein real-time video content requests are also received from a plurality of personal computer systems.

6. The method of claim 1, wherein real-time most watched content associated with a particular category is displayed first.

7. The method of claim 1, wherein the real-time most watched electronic program guide comprises a listing of channels sorted based on popularity.

8. The method of claim 1, wherein the real-time most watched electronic program guide comprises a listing of channels and video on demand clips sorted based on popularity.

9. The method of claim 1, wherein real-time video content requests from the plurality of client devices allow the server to determine the popularity of particular programs in real-time.

10. The method of claim 1, further comprising receiving a selection of content based on the real-time most watched electronic program guide from the first client device.

11. The method of claim 1, further comprising transmitting the selected content to the first client device.

12. A system, comprising:
an interface operable to receive real-time video content requests from a plurality of client devices;
a processor operable to compile a real-time most watched electronic program guide, wherein real-time video content requests are used to derive an ordering of content for the real-time most watched electronic program guide;
wherein the interface is further operable to receive a request for electronic program guide information from a first client device and send the real-time most watched electronic program guide to the first client device for display on the first client device, wherein real-time most watched electronic program guide content is provided before least watched electronic program guide content.

13. The system of claim 12, wherein the real-time most watched electronic program guide is provided to the first client device in blocks.

14. The system of claim 13, wherein a first block includes real-time most watched content.

15. The system of claim 14, wherein subsequent blocks include a channel order program guide.

16. The system of claim 12, wherein real-time video content requests are also received from a plurality of personal computer systems.

17. The system of claim 12, wherein real-time most watched content associated with a particular category is displayed first.

18. The system of claim 12, wherein the real-time most watched electronic program guide comprises a listing of channels sorted based on popularity.

19. The system of claim 12, wherein the real-time most watched electronic program guide comprises a listing of channels and video on demand clips sorted based on popularity.

20. The system of claim 12, wherein real-time video content requests from the plurality of client devices allow the server to determine the popularity of particular programs in real-time.

21. The system of claim 12, further comprising receiving a selection of content based on the real-time most watched electronic program guide from the first client device.

22. The system of claim 12, further comprising transmitting the selected content to the first client device.

23. An apparatus, comprising:
means for receiving real-time video content requests from a plurality of client devices;
means for compiling a real-time most watched electronic program guide, wherein real-time video content requests are used to derive an ordering of content for the real-time most watched electronic program guide;
means for receiving a request for electronic program guide information from a first client device;
means for sending the real-time most watched electronic program guide to the first client device for display on the first client device, wherein real-time most watched electronic program guide content is provided before least watched electronic program guide content.

24. The apparatus of claim 23, wherein the real-time most watched electronic program guide is provided to the first client device in blocks.

25. The apparatus of claim 24, wherein a first block includes real-time most watched content.
